(19) United States
(12) Patent Application Publication
(10) Pub. No.: US 2006/0163994 A1
(43) Pub. Date: Jul. 27, 2006

(54) Vacuum display device with increased resolution

(76) Inventor: Daniel Martijn Damen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/527,006

(22) PCT Filed: Sep. 1, 2003
(86) PCT No.: PCT/IB03/03891

§ 371 Date: Mar. 7, 2005

(30) Foreign Application Priority Data
Sep. 10, 2002 (EP) 02078730.5

(51) Int. Cl. H01J 1/02

(52) U.S. Cl. 313/309

(57) ABSTRACT

A display device has a display screen (130) comprising a first array of picture elements (135) for displaying image information, and cathode means (120) for emitting electrons. The picture elements (135) are grouped together in sub-arrays (132). The emitted electrons are collected by an electron concentrator (115) which redistributes the electrons into a homogenous electron beam (EB). A single electron concentrator (115) is present for each sub-array (132) of picture elements (135), and the display device has selection means (140) for deflecting the electron beam (EB) leaving an electron concentrator (115) to any picture element (135) of the corresponding sub-array (132). Thereby, the displayed image may have a relatively high resolution. In a preferred embodiment, the image brightness is particularly high and variations in brightness uniformity over the displayed image are reduced.

The invention relates to a display device, comprising:

a display screen for displaying image information, said display screen comprising a first array of picture elements;

cathode means for emitting electrons and

a number of electron concentrators for collecting the electrons, an electron concentrator having an exit aperture for releasing an electron beam impinging on a picture element of the display screen.

An embodiment of such a display device is described for instance in unpublished European patent application 01204291.7.

In the previously described display device, the display screen comprises a number of picture elements (pixels) arranged in rows and columns. Each pixel corresponds to an electron beam guidance cavity, which concentrates and redistributes electrons emitted by the cathode means into an electron beam. Thus, in operation, each pixel receives a separate electron beam. The display device comprises addressing means to select each pixel and modulate the beam current of the electron beam impinging on that pixel, in correspondence with image information that is supplied to the display device. Pixels are generally selected by means of row electrodes and column electrodes, which are provided with a row selection voltage and a column selection voltage respectively.

Electrons emitted from a relatively large cathode area are concentrated into an electron beam. Because of this, the beam current of the electron beam is relatively unaffected by a variation of the electron emission properties over the cathode means area. The electron beam impinging on the display screen is particularly uniform.

This advantage is particularly relevant if the cathode means comprises field emitters, which usually show substantial inhomogenity in emission properties over the emitter area. Here, the beam current of the electron beam is the summed emission current of the field emitters over the entire cathode means area corresponding to an electron concentrator. Because of this, the beam current/drive voltage characteristics of the different electron beams are particularly similar, and brightness uniformity between different pixels of the display screen is particularly high as well.

The electron beams are accelerated to the display screen, because the display screen is supplied with a relatively high anode voltage, for instance 5 kilovolts. The pixels comprise luminescent material that emits light when struck by a beam of accelerated electrons. By addressing the pixels in accordance with image information supplied to the display device, said image information can be displayed on the display screen as a light image.

The previously described display device has the problem that it is difficult to achieve a high resolution of the displayed image, while maintaining a good image quality.

For instance, the display device is not suitable for use as a computer monitor having a display screen diagonal of 21 inches and XGA resolution (1280×1024 picture elements) or UXGA resolution (1600×1200 picture elements). This is especially true for a color monitor, wherein a color pixel comprises for instance three primary color sub-pixels.

It is therefore an object of the invention to provide a display device as described in the opening paragraph, which is able to display an image having a relatively high resolution and good quality.

This object is achieved by the display device according to the invention, as specified in the independent Claim 1. Further advantageous embodiments are defined in the dependent Claims 2-11.

A display device according to the invention is therefore characterized in that the first array comprises a predetermined number of sub-arrays, a sub-array comprising at least two of the picture elements, a single electron concentrator is associated with a single sub-array, so that the number of the electron concentrators matches the number of the sub-arrays, and the display device comprises selection means for deflecting the electron beam to one of the picture elements within the sub-array.

The invention is based on the recognition that the achievable image resolution is, among other things, determined by the minimum distance between adjacent electron concentrators.

Generally, the electron concentrators are formed in a substrate, for example a plate. A proper operation of an electron concentrator requires for the diameter of this electron concentrator to be at least 200 micrometers and more preferably at least 300 micrometers.

If the diameter of the electron concentrator is smaller, it does not collect a large enough number of electrons, so that the electron beam exiting from the electron concentrator is relatively weak. Moreover, the concentrating function of the electron concentrator is then insufficient, and the electron beam is relatively inhomogeneous. These effects reduce the brightness of the displayed image, and also variations in brightness are visible, both within single pixels and between different pixels.

For instance in a 21 inch diagonal color UXGA monitor, 4800 color sub-pixels have to be provided within a horizontal width of approximately 425 millimeters. This requires a distance between adjacent picture elements of approximately 90 micrometers. In this case, adjacent electron concentrators should also be spaced apart by a 90 micrometer distance which is significantly less than the minimum diameter that is required for proper operation of the electron concentrator.

By applying the invention, the picture elements are arranged in sub-arrays, while an electron concentrator corresponds to a sub-array of pixels. The electron beam exiting from the electron concentrator is deflectable by the selection means and may thereby impinge on any picture element within the sub-array associated with the electron concentrator.

A 1:1 ratio of the distance between adjacent electron concentrators to the distance between adjacent pixels is no longer required. The electron concentrators can now be spaced apart further, while adjacent pixels remain at a relatively small distance. Thereby, proper functioning of the electron concentrators can be ensured, while the image resolution can be increased as desired. The displayed image may now both have a relatively high resolution and relatively good quality.

In the above-mentioned example, a sub-array comprises three color sub-pixels corresponding to the primary phosphor colors red, green and blue. The electron beam exiting from an electron concentrator may subsequently be deflected to the red, green and blue phosphor sub-pixels, so that the human eye perceives a color picture element. In this example, the distance between adjacent electron concentrators can be equal to 3×90=270 micrometers, which is a sufficiently high value.

When applying the present invention, a further advantage is that the number of voltages required to address the pixels of the display device is reduced. For instance, the sub-arrays are now arranged in rows and columns, instead of the individual pixels. Thus, the required number of row and column selection voltages is determined by the number of sub-arrays, instead of the number of pixels. Only a few deflection voltages are required to deflect an electron beam to any pixel within a sub-array. These deflection voltages are advantageously supplied to each of the selection means at the same time.

In the above-mentioned example relating to a color display device, the number of columns is reduced by a factor of three, because a column now comprises three differently colored pixels. Thus, the number of column selection voltages is also reduced by a factor of three. The electron beams are deflected in one direction to the respective color pixels, which deflection may be achieved by two deflection voltages at most. In an UXGA color display, the number of addressing voltages is reduced from 6000 (=1600×3+1200) to 2802 (=1600+1200+2). This advantage becomes even greater as a sub-array comprises more picture elements.

Preferably, the electron concentrator comprises the selection means.

This is a particularly efficient way to carry out the invention. In this way, the electron beam may be deflected as it leaves the electron concentrator. The electrons still have a relatively low speed then, and consequently the electrons feel the deflection field well. The strength of the deflection field may be relatively low, whereas a sufficient amount of deflection is obtained.

Preferably, the electron concentrator comprises an electron beam guidance cavity which is provided with secondary emission material and has an entrance larger than the exit aperture, whereby a hop electrode is arranged near said exit aperture for enabling a hopping transport of the electrons to said aperture.

This is a particularly efficient embodiment of the electron concentrator. Electron beam guidance based on hopping transport of the electrons is known per se from U.S. Pat. No. 5,270,611.

Hopping transport of the electrons is based on a secondary emission process. In operation, the hop electrode receives a hop voltage, so that electrons in the cavity are accelerated to the exit aperture. The inner surface of the cavity comprises an electrically insulating material having a secondary emission function. When an electron strikes upon the inner surface, it is absorbed and a secondary electron is released and accelerated to the exit aperture. For each emitted electron that enters the cavity, on average one electron is emitted from the exit aperture. Thus, on average, as many electrons leave the cavity as enter it and the electron beam is guided through the cavity.

The cavity collects the electrons from the relatively large entrance, and concentrates and redistributes them into an electron beam exiting through the relatively small exit aperture.

The ratio between the surface areas of the entrance and the exit aperture is for instance 5:1, but may have a value of 10:1 or more, for example 20:1, 50:1 or 100:1. An electron concentrator is now advantageously associated with a tile of picture elements, for instance 2×2 or 3×3 picture elements. The entrance is relatively large in this embodiment, and thus electrons are drawn from a relatively large part of the cathode means. Thereby, the beam current of the electron beam exiting from the electron concentrator may be particularly high. Also, the electron beam is particularly homogenous, so that the displayed image shows relatively few intensity variations.

In a preferred embodiment, the selection means then comprise an outer electrode arranged substantially outside the hop electrode, said outer electrode having at least two segments on opposing sides of the exit aperture, between which segments a deflection voltage is applied for deflecting the electron beam.

The segments of the outer electrode are, on average, at a lower voltage than the hop voltage. Thus, an electron lens is formed which confines the exiting electron beam. Because of the deflection voltage, an electric field is formed between the segments of the outer electrode, which field acts transversely on the exiting electron beam. Thereby, said electron beam is deflectable to a picture element within the sub-array corresponding to the electron concentrator.

In a preferred embodiment, a sub-array comprises an even number of picture elements, a center of the sub-array being aligned to a main axis of the electron beam guidance cavity. In this setup, an undeflected electron beam exiting from the cavity lands in the center of the sub-array. Generally, the landing position is then in between pixels, where preferably a black matrix material is provided. During operation, the electron beam always impinges on a pixel, so that in this preferred embodiment the addressing of the display device always requires deflection of the electron beam by the selection means.

The display device operates under vacuum conditions, however in practice residual gases are always present in the display device, even after evacuation. Between the exit aperture and the display screen, electrons in the beam may collide with residual gas atoms, which are thereby ionized. Thus, positive ions are formed which are repelled by the anode voltage and accelerated to the electron concentrators.

In this embodiment, the electron beam is deflected by the voltage difference over the segments of the outer electrode. However, when the positive ions arrive at the exit aperture, they have gained a relatively high speed. Thus, the ions are hardly deflected by the voltage difference, and generally collide with the plate in which the electron beam guidance cavities are provided. As a consequence, the fraction of the positive ions that passes through the exit aperture, to the cathode means, is reduced. This is an advantage, since impact of positive ions on the cathode means causes damage thereto. The cathode damage is therefore reduced in this embodiment.

Preferably, the cathode means comprises a field emitter. Field emitters require only a relatively low power for generating a sufficiently large number of electrons.

These and other aspects of the invention will be apparent from and elucidated with reference to the embodiment described hereinafter.

In the drawings:

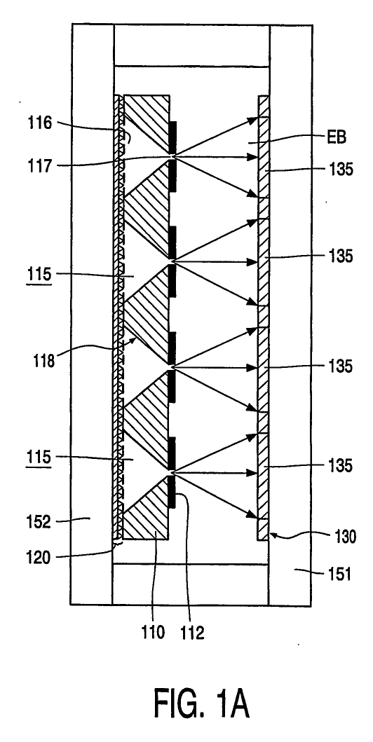

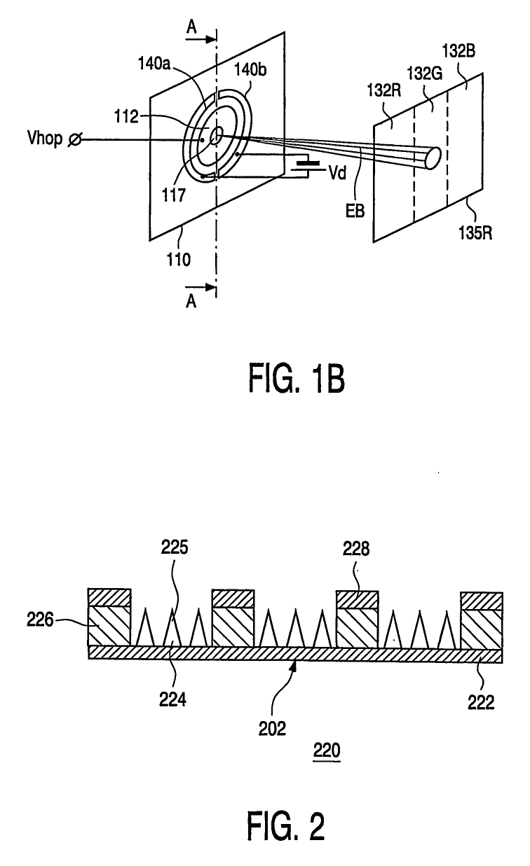

FIG. 1A is a first preferred embodiment of the display device according to the present invention;

FIG. 1B shows the selection means and a sub-array of pixels in the first preferred embodiment, in more detail;

FIG. 2 shows an embodiment of cathode means suitable for use in the display device;

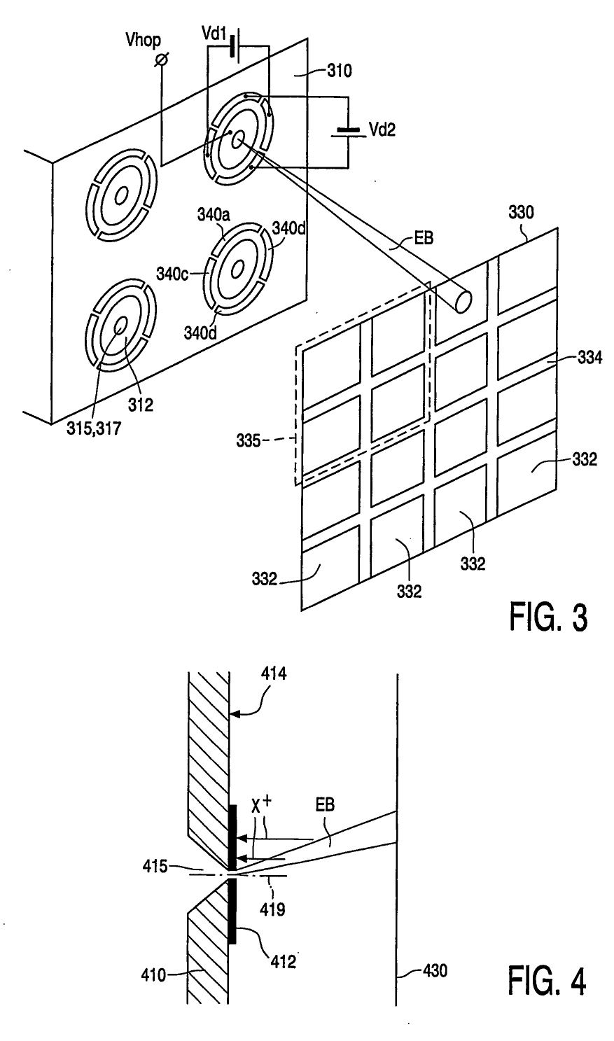

FIG. 3 shows the selection means and a sub-array of pixels in a second preferred embodiment of the display device, and

FIG. 4 shows the generation of positive ions in the display device, by a deflected electron beam.

A first preferred embodiment of the display device has a display screen 130 arranged near a front plate 151, and cathode means 120 arranged near a back plate 152, for forming a plurality of electron beams EB. The front plate 151 facing the viewer may be substantially flat, and the display device can be relatively thin. The thickness of the entire structure could be 1 centimeter or less.

The rectangular display screen 130 comprises picture elements (which for reason of clarity are also referred to as “sub-pixels” hereinafter) 132R,G,B that together constitute a sub-array (which is referred to as “color pixel” hereinafter) 135. Whereas in FIG. 1A a display device is shown that has only a few color pixels 135, a real display device has a much larger number of color pixels, for instance 1024×768, 1280×1024 or 1600×1200. The display screen 130 is at a relatively high anode voltage, for instance 10 kV, for accelerating an electron beam EB to the screen.

Each sub-pixel 132R,G,B is provided with a luminescent material, for instance a phosphor, which emits light when it is struck by an electron beam EB. Different luminescent materials are applied, each corresponding to one of the primary colors red, green and blue. The light emitted from the sub-pixel 132R,G,B travels through the front plate 151 to a viewer, who watches the display device at a certain distance, and perceives the three sub-pixels as a single color pixel 135. The dimensions of a sub-pixel 132R,G,B are for instance 100 by 300 micrometers.

A plate-shaped substrate 110 is arranged between the display screen 130 and the cathode means 120, usually in proximity to the latter. The substrate 110 is provided with electron concentrators 115. Preferably, the electron concentrators 115 are electron beam guiding cavities that are substantially funnel-shaped, and have an entrance 116 for collecting the electrons emitted by the cathode means 120 and an exit aperture 117 for releasing an electron beam EB. Within the electron concentrators 115, the emitted electrons are redistributed and concentrated in the electron beam EB, which has a relatively high beam current and a relatively homogenous electron distribution. Such electron concentrators are known from cited U.S. Pat. No. 5,270,611.

For any color pixel 135, the substrate 110 has a corresponding electron concentrator 115. The inner surface 118 of an electron concentrator 115 is at least partially coated with an electrically insulating material having a secondary emission coefficient δ of at least one for a predetermined range of electron impact energies, so that the inner wall 118 is able to emit a secondary electron when an electron impinges on it. This allows for the so-called hopping transport of electrons through the electron concentrator 115. The secondary emission material comprises, for instance, magnesium oxide (MgO). The substrate 110 has a thickness of for instance 400 μm.

For enabling the hopping electron transport, a hop electrode 112 is present at the screen-facing side of the electron concentrator 115. In operation, a hop voltage is applied to the hop electrode 112 for establishing an electric field within the electron concentrator 115. The hop voltage preferably has a constant value, or is alternatively variable for controlling the beam current of the electron beam EB.

When the hop voltage is equal to a predetermined threshold hop voltage, the hopping transport of electrons starts. By increasing the hop voltage, the beam current of the electron beam EB increases. A maximum hop voltage corresponds to a voltage at which a peak beam current is emitted by the cathode means 120. For instance, the threshold hop voltage lies within a range from 50 to 200 volts, and the maximum hop voltage, being larger than the threshold hop voltage, lies within a range from 100 to 600 volts.

In general, the exit aperture 117 is smaller than the entrance 116 which faces the cathode means 120. Preferably, the ratio of the surface area of the entrance 116 to the exit aperture 117 has a value substantially larger than 1:1, such as 10:1 or 20:1. For example, the diameter of the entrance 116 is 500 micrometers and the diameter of the exit aperture 117 is 50 micrometers. The electron beam EB leaving the electron concentrator 115 now has sufficiently high beam current, and a particularly uniform and homogeneous energy distribution.

Between the substrate 110 and the display screen 130, a screen spacer is arranged similarly to the previously described display device. The spacer keeps the substrate 110 and the display screen 130 at a predetermined distance, for example 2 millimeters, and also functions as an internal vacuum support.

Selection means are provided by means of a segmented outer electrode 140, which is arranged concentrically around the hop electrode 112. This may be observed in FIG. 1B. The outer electrode is divided into two segments 140a, 140b between which a voltage difference may be applied. This voltage difference is referred to as deflection voltage in the following. The outer electrode 140 has the same thickness as the hop electrode 112, for instance 3 micrometers.

By means of the deflection voltage, an electric deflection field is formed near the exit aperture 117 of the electron concentrator 115. If the electric deflection field is present, this causes the electron beam EB to leave the electron beam guidance cavity 115 at an angle with the main axis 118 of the electron concentrator 115. In the first embodiment, the selection means are able to deflect the electron beam EB in one direction only.

For example, the hop voltage is fixed at 500 volts. The beam current of an electron beam EB is then controlled at the cathode side of the electron concentrator 115. The segments 140a,b of the outer electrode receive a fixed voltage Vf, on which the deflection voltage Vd is superimposed so that the average voltage applied to segments 140a, b is equal to Vf. For instance, the fixed voltage Vf is 400 volts. Now, if the deflection voltage is 200 volts, segment 140a receives 300 volts and segment 140b receives 500 volts.

The sub-pixels 132R,G,B corresponding to the different primary colors red, green and blue are alternately laid out along said one direction. If the deflection voltage is zero, no deflection field is present near the exit aperture 117. The electron beam EB remains undeflected and travels substantially in the direction of the main axis 118 of the electron concentrator 115. The electron beam EB impinges on the green sub-pixel 132G.

However, if a deflection voltage of for instance +200 V is applied between the segments 140a,b of the outer electrode, the electron beam EB is deflected as it leaves the exit aperture 117, and impinges on the blue sub-pixel 132B. Correspondingly, if a deflection voltage of for instance −200 V is applied, the electron beam EB impinges on the red sub-pixel 132R.

The selection means could be addressed in several ways. Firstly it is possible to set the deflection voltage to a predetermined value (for instance +0 V) and write an entire frame on the display screen using a conventional “line-at-a-time” pixel addressing scheme. Thus, all green sub-pixels 132G in one line are activated at the same time, and after a preselected period of time said line is deactivated, and the next line is selected.

As a result, the green image information is displayed first. Subsequently, the deflection voltage is changed to for example +200 V, and the blue image information is displayed. Subsequently, the deflection voltage is changed to for example −200 V, and the red image information is displayed. When this addressing is carried out at sufficiently high speed, the viewer perceives a single full-color image.

Alternatively, it is possible to subsequently address each sub-pixel 132R,G,B of a single color picture element 135, so that the full color image information is displayed in a single frame, using a line-at-a-time pixel addressing scheme wherein all color pixels 135 in one line are activated at the same time. After a preselected period of time, said line is deactivated and the next line of color pixels is selected.

FIG. 2 shows, in more detail, a cross-section of cathode means 220 suitable for use in a display device according to the invention.

The cathode means 220 comprise a cathode electrode 222 deposited on the first surface 202 and field emitter material 224 deposited on the cathode electrode 222. Thus, the display device is a Field Emission Display (FED). The advantage of applying field emitters is that they are relatively cheap, and able to emit electrons at relatively low drive voltages.

The field emitter material 224 is provided within holes 225 in a resistive layer 226, which layer is covered by a gate electrode 228. In the drawing, the indicated field emitter material 224 consists of microtip emitters, but any other field emitter material, such as carbon nanotubes or graphite emitting particles, may be applied instead.

By applying a voltage difference between the cathode electrode 222 and the gate electrode 228, the field emitter material 224 is energizable for emitting electrons. This voltage difference can be relatively low, for instance a voltage difference of 100 volts is sufficient to obtain an electron beam EB with a beam current of 20 microamperes.

In a second preferred embodiment of the display device, a 2×2 block of picture elements 332 of the display screen 330 constitutes a sub-array (tile) 335, as can be seen in FIG. 3. The picture elements 332 may comprise luminescent material of a single color, or may themselves comprise several sub-pixels of different colors, so that a color pixel is formed. Each picture element 332 measures for instance 300 by 300 micrometers, and adjacent picture elements are separated by a space of 100 micrometers which is filled with black matrix material 334. This material emits substantially no light when it is struck by the electron beam EB. Thus, a tile 335 measures 800 by 800 micrometers.

Each of the picture elements 332 in the tile 335 is addressable by electron beam EB emitted from the electron concentrator 315. The electron beam EB is therefore deflectable over almost 800 micrometers. The distance between the substrate and the display screen is increased in this embodiment, for instance to 5 millimeters, this prevents the required deflection voltage from becoming too high. For example, an anode voltage of 10 kV now leads to a maximum deflection voltage of 250 V.

Since the tiles 335 extend in two directions, the electron beam EB has to be deflectable in two directions as well. For this reason, a segmented outer electrode 340 is arranged concentrically with the hop electrode 312. The outer electrode 340 now comprises four segments 340a,b,c,d, each extending over an angle of approximately 90 degrees around the hop electrode 312. Two segments 340a,b that are arranged on opposing sides of the hop electrode 312, as seen in a row direction, receive a first deflection voltage Vd1 for deflecting the electron beam EB in said row direction. The two other segments 340c,d, being arranged on opposing sides of the hop electrode 312 as seen in a column direction, receive a second deflection voltage Vd2 for deflecting the electron beam EB in said column direction.

If the pixels 332 are color pixels, a color selection voltage Vc may be superimposed on either the first deflection voltage Vd1 or the second deflection voltage Vd2, for addressing the individual sub-pixels within each color pixel 332.

Alternatively, the tile may comprise a larger number of picture elements, such as 3×3 or 4×4. The electron beam is then deflected over a relatively large distance. To keep the deflection voltages at an acceptable level, the distance between substrate and display screen should be increased further, and/or the anode voltage should be larger. For instance, when using a 4×4 tile of pixels, the distance may be increased to 8 millimeters and the anode voltage to 20 kV, in order to limit the required deflection voltages around 200 V.

For example, the hop voltage is fixed at 500 volts. The segments 340a,b,c,d of the outer electrode receive a fixed voltage Vf of for instance 400 volts, on which the deflection voltages Vd1, Vd2 are superimposed.

Alternatively, it is possible to apply two separate fixed voltages Vf1, Vf2. For instance, segments 340a,b receive the first fixed voltage Vf1 with the first deflection voltage Vd1 superimposed thereon, and segments 340c,d receive the second fixed voltage Vf2 with the second deflection voltage Vd2 superimposed thereon. In this way it is possible to adapt the shape of the electron beam EB as it leaves the electron concentrator 315. This is advantageous if the electron beam EB is deflected through a relatively large angle and as a consequence lands on the display screen 330 at a relatively large angle. In this case, the spot of the electron beam EB on the screen is deformed. This deformation may be compensated for in this embodiment.

During operation, in the second preferred embodiment, the first and second deflection voltages Vd1, Vd2 are non-zero at all times. Thus, the electron beam EB, when leaving the electron concentrator 315, is always deflected. As can be observed in FIG. 4, in case the electron beam EB is deflected, and leaves the electron concentrator 415 at a preselected angle to its main axis 419, the positive ions X⁺ that are generated from residual gases between the substrate 410 and the display screen 430 do not reach the electron concentrator 415. Rather, they land on the screen-facing surface 414 of the substrate 410.

This is an advantage. When positive ions X⁺ are able to reach the electron concentrator 415, they may damage the coating on its inner wall, its exit aperture or the hop electrode near the exit aperture.

As a result, the operation of the electron concentrator 415 deteriorates, and the lifetime of the display device is reduced. In the second preferred embodiment, the amount of positive ions that reaches the electron concentrator 415 is reduced, so that the ion damage inflicted on the electron concentrator 415 is minimized.

The drawings are schematic and were not drawn to scale. While the invention has been described in connection with preferred embodiments, it should be understood that the invention should not be construed as being limited to the preferred embodiments. Rather, it includes all variations which could be made thereon by a skilled person, within the scope of the appended claims.

Although the advantages of the present invention are most notable in a Field Emission Display as set out in this patent application, other types of flat displays relying on the generation and transport of electron beams may also benefit from the application of the present invention.

Summarizing, the present invention relates to a display device having a display screen comprising a first array of picture elements for displaying image information, and cathode means for emitting electrons. The picture elements are grouped together into sub-arrays. The emitted electrons are collected by an electron concentrator which redistributes the electrons into a homogenous electron beam (EB). A single electron concentrator is present for each sub-array of picture elements, and the display device has selection means for deflecting the electron beam leaving an electron concentrator to any picture element of the corresponding sub-array. As a result, the displayed image may have a relatively high resolution. In a preferred embodiment, the image brightness is particularly high and variations in brightness uniformity over the displayed image are reduced.

1. Display device, comprising:
a display screen (130) for displaying image information, said display screen (130) comprising a first array of picture elements (135);
cathode means (120) for emitting electrons and
a number of electron concentrators (115) for collecting the electrons, an electron concentrator (115) having an exit aperture (117) for releasing an electron beam (EB) impinging on a picture element (135) of the display screen (130), characterized in that
the first array comprises a predetermined number of sub-arrays (132), a sub-array (132) comprising at least two of the picture elements (135),
a single electron concentrator (115) is associated with a single sub-array (132), so that the number of the electron concentrators (115) matches the number of the sub-arrays (132), and
the display device comprises selection means (140) for deflecting the electron beam (EB) to one of the picture elements (135) within the sub-array (132).

2. Display device as claimed in claim 1, characterized in that the electron concentrator (115) comprises the selection means (140).

3. Display device as claimed in claim 1, characterized in that the electron concentrator (115) comprises an electron beam guidance cavity being provided with secondary emission material and having an entrance (116) being larger than the exit aperture (117), a hop electrode (112) being arranged near said exit aperture (117) for enabling a hopping transport of the electrons to said exit aperture (117).

4. Display device as claimed in claim 4, characterized in that a ratio between a surface area of the entrance (116) and a surface area of the exit aperture (117) is at least 10:1.

5. Display device as claimed in claim 2, characterized in that the selection means (140) comprise an outer electrode (114) arranged substantially outside the hop electrode (112), said outer electrode (114) having at least two segments on opposing sides of the exit aperture (117), between which segments a deflection voltage is applied for deflecting the electron beam (EB).

6. Display device as claimed in claim 5, characterized in that a sub-array comprises an even number of picture elements, a center of the sub-array being aligned with a main axis of the electron beam guidance cavity.

7. Display device as claimed in claim 1, characterized in that a sub-array comprises three picture elements (135R,G,B) corresponding to primary phosphor colors of the display screen (130).

8. Display device as claimed in claim 1, characterized in that cathode means (120) comprises a field emitter (224).
